(19) United States
(12) Patent Application Publication
(10) Pub. No.: US 2015/0199332 A1
(43) Pub. Date: Jul. 16, 2015

(54) BROWSING HISTORY LANGUAGE MODEL FOR INPUT METHOD EDITOR

(71) Applicants: Mu Li, Beijing (CN); Xi Chen, Tianjin (CN)

(72) Inventors: Mu Li, Beijing (CN); Xi Chen, Tianjin (CN)

(21) Appl. No.: 14/423,950

(22) PCT Filed: Aug. 31, 2012
(86) PCT No.: PCT/CN2012/080815

§ 371 Date: Feb. 25, 2015

Related U.S. Application Data
(60) Provisional application No. 61/674,097, filed on Jul. 20, 2012.

(51) Int. Cl. G06F 17/27; G06F 17/30; H04L 29/08

(52) U.S. Cl. CPC G06F 17/275; H04L 67/2842; G06F 17/30902

(57) ABSTRACT

Some examples may include generating a browsing history language model based on browsing history information. Further, some implementations may include predicting and presenting a non-Latin character string based at least in part on the browsing history language model, such as in response to receiving a Latin character string via an input method editor interface.

### CROSS REFERENCE TO RELATED APPLICATIONS

This application is a 35 U.S.C. 371 National Stage Application of International Application No. PCT/CN2012/080815, filed Aug. 31, 2012, the entire contents of which are incorporated herein by reference.

### TECHNICAL FIELD

This disclosure relates to the technical field of computer input.

### BACKGROUND

An input method editor (IME) is a computer functionality that assists a user to input text into a host application of a computing device. An IME may provide several suggested words and phrases based on received inputs from the user as candidates for insertion into the host application. For example, the user may input one or more initial characters of a word or phrase and an IME, based on the initial characters, may provide one or more suggested words or phrases for the user to select a desired one.

For another example, an IME may also assist the user to input non-Latin characters such as Chinese. The user may input Latin characters through a keyboard. The IME returns one or more Chinese characters as candidates for insertion. The user may then select the proper character and insert it. As many typical keyboards support inputting Latin characters, the IME is useful for the user to input non-Latin characters using a Latin-character keyboard.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Some implementations provide techniques and arrangements for predicting a non-Latin character string based at least in part on a browsing history language model. The browsing history language model may be generated based on browsing history information. For example, the browsing history information may include at least cached browsing content and may also include real-time browsing content. The predicted non-Latin character string may be provided in response to receiving a Latin character string via an input method editor interface. Additionally, some examples may predict a Chinese character string based at least in part on the browsing history language model in response to receiving a Pinyin character string.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example system according to some implementations.

FIG. 2 illustrates an example input method editor interface according to some implementations.

FIG. 3 illustrates an example input method editor interface according to some implementations.

FIG. 4 illustrates an example process flow according to some implementations.

FIG. 5 illustrates an example process flow according to some implementations.

FIG. 6 illustrates an example system in which some implementations may operate.

### DETAILED DESCRIPTION

### Overview

Some examples include techniques and arrangements for implementing a browsing history language model with an input method editor (IME). For instance, it may be difficult for a user to input characters into a computer for a language that is based on non-Latin characters (e.g., the Chinese language). For example, there are thousands of Chinese characters, and a typical Western keyboard is limited to 26 letters. The present disclosure relates to an IME that predicts a non-Latin character string in response to receiving a Latin character string from a user. The predicted non-Latin character string is based at least in part on a browsing history language model. As an illustrative, non-limiting example, the IME may be used to translate Pinyin text (i.e., Chinese characters represented phonetically by Latin characters) into Chinese characters. It will be appreciated that the present disclosure is not limited to Chinese characters. For example, other illustrative non-Latin characters may include Japanese characters or Korean characters, among other alternatives.

Among Chinese input method editors, those based on Pinyin text are the most common. Chinese Pinyin is a set of rules that utilize the Latin alphabet to annotate the pronunciations of Chinese characters. In a typical Pinyin IME, users input the Pinyin text of the Chinese they want to input into the computer, and the IME is responsible for displaying all the matched characters. However, many Chinese characters have the same pronunciation. That is, there is a one-to-many relationship between the Pinyin text and the corresponding Chinese characters. To predict a non-Latin character string, an IME may rely on a language model. For example, a statistical language model (SLM) may be used to compute a conversion probability of each possible conversion and may select the one with the highest probability for presentation to a user. A particular type of SLM, referred to as an N-gram SLM, may decompose the probability of a string of consecutive words into the products of the conditional probabilities between two, three, or more consecutive words in the string.

An IME may be released with a language model for generic usage (i.e., a “general” language model), which is trained for most common typing scenarios. However, such a general language model may be inadequate for a particular user (e.g., a user with a particular browsing history). That is, different users may have different preferences, and an IME that utilizes a general language model may suggest a word or phrase that may be inappropriate for a particular user. To illustrate, an IME that utilizes a general language model may suggest a first word or phrase (i.e., a first set of non-Latin characters). The first word or phrase may have the same pronunciation as a second word or phrase (i.e., a second set of non-Latin characters). The first word or phrase may be appropriate for a standard user but may be less appropriate for another user. Instead, the second word or phrase may be more appropriate for such a user.

Web browsing history is an important source of information about a user. For example, a user may browse content related to recent news events or may browse special topics that the user may be interested in. For example, a computer programmer may browse one or more portal sites for various news items and may also browse one or more software development sites. As such, the browsing history of the user may contain the latest general hot topics and texts related to programming skills, among other information.

The present disclosure describes an IME that utilizes a browsing history language model to predict a non-Latin character string that may be more appropriate for a user with a particular browsing history than a non-Latin character string that is predicted based on the general language model.

### Example Implementations

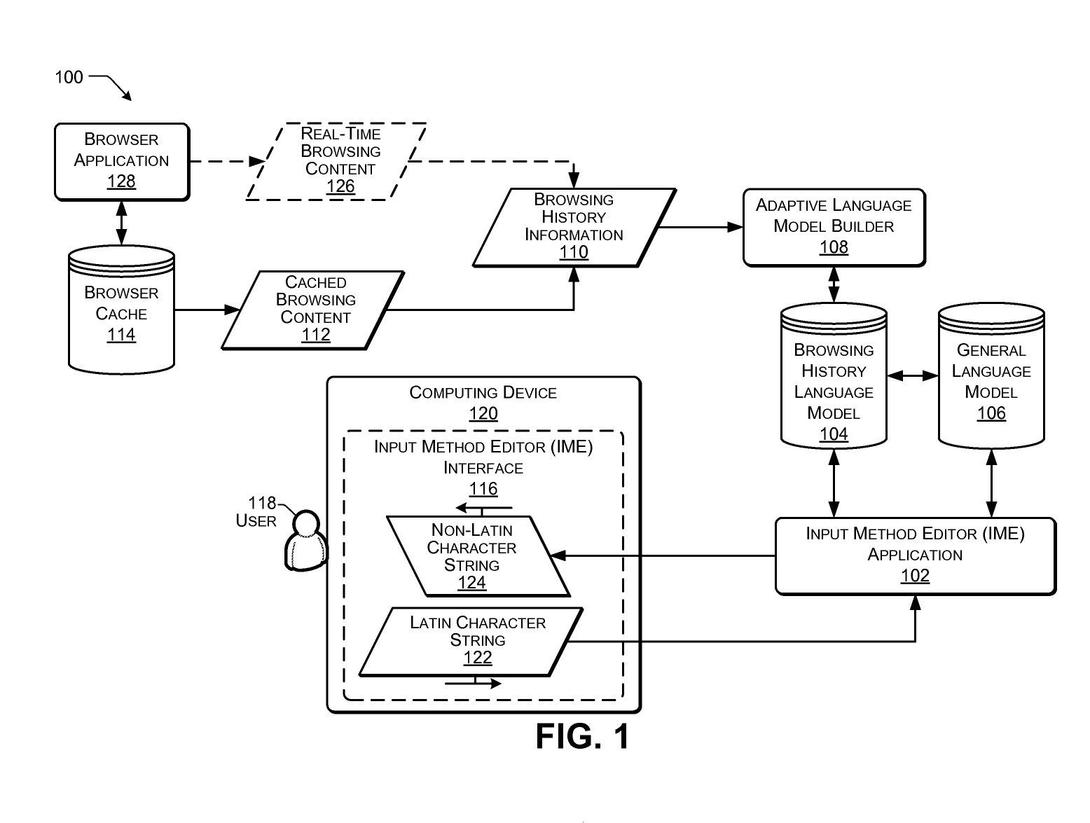

FIG. 1 illustrates an example framework of a system 100 according to some implementations. The system 100 includes an input method editor (IME) application 102 that is communicatively coupled to a browsing history language model 104 and a general language model 106. The system 100 further includes an adaptive language model builder 108 that is adapted to receive browsing history information 110. The browsing history information 110 may include at least cached browsing content 112 stored at a browser cache 114. An IME interface 116 may be provided to a user 118 via a computing device 120. While the computing device 120 is shown in FIG. 1 as separate from the above described components of the system 100, it will be appreciated that this is for illustrative purposes only. For instance, in some examples, all of the components of the system 100 may be included on the computing device 120, while in other examples, the components may be distributed across any number of computing devices able to communicate with one another, such as over one or more networks or other communication connections.

The IME application 102 is configured to generate the IME interface 116 for display to the user 118 via the computing device 120. The adaptive language model builder 108 is configured to generate the browsing history language model 104 based on the browsing history information 110. The IME application 102 is further configured to receive a Latin character string 122 via the IME interface 116. In response to receiving the Latin character string 122, the IME application 102 is configured to predict a non-Latin character string 124 based at least in part on the browsing history language model 104.

The adaptive language model builder 108 may generate the browsing history language model 104 based on an analysis of the browsing history information 110. For example, the browsing history language model 104 may include an N-gram statistical language model. Such an N-gram statistical language model may decompose the probability of a string of consecutive words into the products of the conditional probabilities between multiple (e.g., two, three, four, five, etc.) consecutive words in the string. Such analysis may be performed for each of the one or more files 112.

Some implementations provide a system service that may periodically monitor the browser cache 114 to determine whether new browsing content has been saved to the browser cache 114. In response to determining that new browsing content has been saved, the adaptive language model builder 108 may process the new browsing content to update the browsing history language model 104. In some implementations, the browsing history information 110 may also include real-time browsing content 126, as shown in phantom. For example, a plug-in of a browser application 128 (e.g., a web browser application) may detect new browsing content in substantially real-time and provide the real-time browsing content 126 to the adaptive language model builder 108. The adaptive language model builder 108 may process the real-time browsing content 126 to update the browsing history language model 104. In some implementations, the plug-in of the browser application 128 may not provide real-time browsing information when a browsing mode is set to private browsing. That is, the browsing history information 110 may optionally only include the cached browsing content 112 that is stored at the browser cache.

The IME application 102 receives the Latin character string 122 via the IME interface 116. As an illustrative example, the Latin character string 122 may include Pinyin text, and the predicted non-Latin character string 124 may include one or more Chinese characters.

A plurality of non-Latin character strings may be associated with the Latin character string 122 received via the IME interface 116. A conversion probability may be associated with each non-Latin character string of the plurality of non-Latin character strings. The IME application 102 may predict the non-Latin character string 124 for display to the user 118 based at least in part on the browsing history language model 104. In a particular embodiment, the IME application 102 predicts the non-Latin character string 124 by identifying the non-Latin character string with a highest conversion probability. The IME application 102 may order the plurality of non-Latin character strings based on the conversion probability and may display an ordered list of non-Latin character strings via the IME interface 116.

In some implementations, one or more predicted non-Latin character strings may be determined based on the browsing history language model 104 and the general language model 106. As an illustrative example, C may represent the Chinese string to be predicted, Pₘ(C) may represent a probability determined based on the general language model 106, and P_{b}(C) may represent a probability determined based on the browsing history language model 104. A contribution of the browsing history language model 104 may be determined based on a weighting factor (e.g., a value between 0 and 1, referred to herein as λ). That is, the probability of C may be determined based on the formula: P(C)=λPₘ(C)+(1−λ)P_{b}(C).

In some implementations, the weighting factor λ may include a default weighting factor. That is, the weighting factor can be “pre-tuned” to a weighting factor that has been previously verified as accurate in most cases. In another embodiment, the weighting factor may include a user-defined weighting factor. For example, the user-defined weighting factor may be received from the user 118, and the weighting factor may be modified from the default weighting factor to the user-defined weighting factor. This may allow the user 118 to “tune” the weighting factor according to personal preference.

The general language model 106 may identify a first non-Latin character string as the non-Latin character string with the highest conversion probability. The browsing history language model 104 may identify a second non-Latin character string as the non-Latin character string with the highest conversion probability. The first non-Latin character string identified by the general language model 106 may be different than the second non-Latin character string identified by the browsing history language model 104.

As an illustrative example, the Latin character string 122 received from the user 118 may be the Pinyin text “wan′shang′shi′shi.” Based on the browsing history information 110, the browsing history language model 104 may predict that the Chinese character string [symbol] (meaning “10 P.M.”) is more appropriate for display than the Chinese character string [symbol] (meaning “have a try in the evening”) predicted by the general language model 106.

As another illustrative example, the Latin character string 122 received from the user 118 may be the Pinyin text “you′xiang′tu.” Based on the browsing history information 110, the browsing history language model 104 may predict that the Chinese character string [symbol] (meaning “directed graph”) may be more appropriate for display than the Chinese character string [symbol] (meaning “gas tank diagram”) predicted by the general language model 106.

Thus, FIG. 1 illustrates that the non-Latin character string 124 displayed via the IME interface 116 may vary depending on whether the browsing history language model 104 identifies the non-Latin character string 124 as more appropriate for display based on the browsing history information 110.

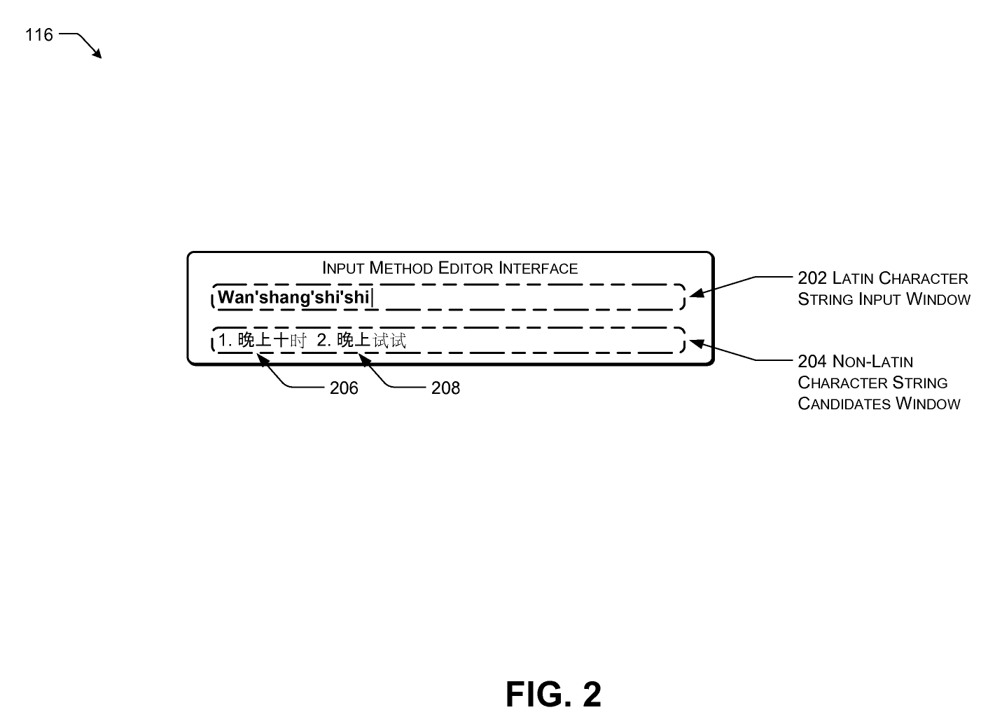

FIG. 2 illustrates an example of an input method editor (IME) interface 116 according to some implementations. To illustrate, the IME interface 116 of FIG. 2 may correspond to the IME interface 116 of FIG. 1.

The IME interface 116 includes a Latin character string input window 202 and a non-Latin character string candidates window 204. The Latin character string input window 202 is configured to receive a Latin character string (e.g., the Latin character string 122 of FIG. 1). The non-Latin character string candidates window 204 is configured to display one or more non-Latin character string candidates.

FIG. 2 illustrates that a plurality of non-Latin (e.g., Chinese) character strings may be associated with the Latin character string received via the IME interface 116. A conversion probability may be associated with each of the non-Latin character strings. An IME application (e.g., the IME application 102 of FIG. 1) may order the non-Latin character strings based on conversion probability and may display an ordered list of non-Latin character strings via the IME interface 116.

In the example illustrated in FIG. 2, the Latin character string received via the Latin character string input window 202 may be the Pinyin text “wan′shang′shi′shi.” The non-Latin character string candidates window 204 displays a first Chinese character string candidate 206 (i.e., [symbol] ) and a second Chinese character string candidate 208 (i.e., [symbol] ). For example, the browsing history language model 104 may identify the first Chinese character string candidate 206 (i.e., [symbol] ) as the Chinese character string with a highest conversion probability. The general language model 106 may identify the second Chinese character string candidate 208 (i.e., [symbol] ) as the Chinese character string with a highest conversion probability.

As explained above, based on the browsing history information 110, the Chinese character string [symbol] (meaning “10 P.M.”) may be more appropriate for display than the Chinese character string [symbol] (meaning “have a try in the evening”) predicted by the general language model 106. As such, the first Chinese character string candidate 206 (i.e., [symbol] ) predicted by the browsing history language model 104 may be identified as having a higher conversion probability than the second Chinese character string candidate 208 (i.e., [symbol] ) predicted by the general language model 106. Accordingly, the Chinese character string [symbol] [symbol] may be presented as the first Chinese character string candidate 206 in the non-Latin character string candidates window 204.

In the example illustrated in FIG. 2, the Chinese character string [symbol] [symbol] predicted by the general language model 106 is provided as the second Chinese character string candidate 208 in the non-Latin character string candidates window 204. However, it will be appreciated that alternative non-Latin character string candidates may be presented. For example, alternative Chinese character strings predicted by the browsing history language model 104 may be presented. Further, while only two candidates are illustrated in the non-Latin character string candidates window 204, alternative numbers of candidates may be displayed.

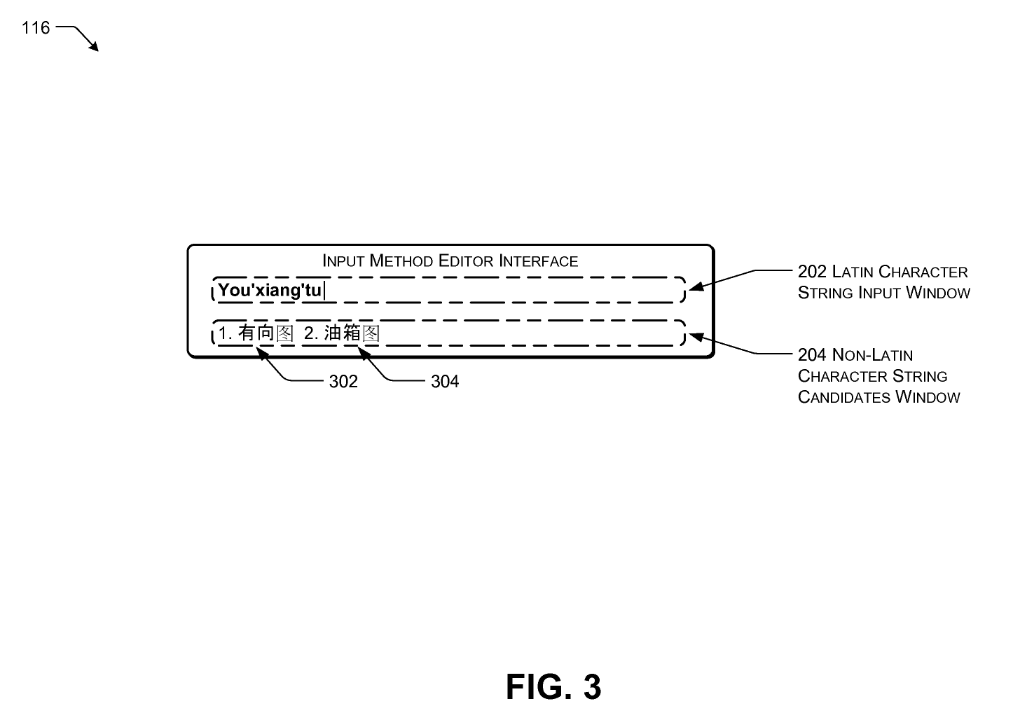

FIG. 3 illustrates the exemplary input method editor interface 116 after receiving a Latin character string input that is different than the Latin character string input of FIG. 2.

In the example illustrated in FIG. 3, the Latin character string received via the Latin character string input window 202 may be the Pinyin text “you′xiang′tu.” The non-Latin character string candidates window 204 displays a first Chinese character string candidate 302 (i.e., [symbol] ) and a second Chinese character string candidate 304 (i.e., [symbol] ). As explained above, based on the browsing history information 110, the Chinese character string [symbol] (meaning “directed graph”) may be more appropriate for display than the Chinese character string [symbol] (meaning “gas tank diagram”). As such, the Chinese character string [symbol] may be presented as the first Chinese character string candidate 302 in the non-Latin character string candidates window 204.

In the example illustrated in FIG. 3, the Chinese character string [symbol] is provided as the second Chinese character string candidate 304 in the non-Latin character string candidates window 204. However, it will be appreciated that alternative non-Latin character string candidates may be presented. Further, while only two candidates are illustrated in the non-Latin character string candidates window 204, alternative numbers of candidates may be displayed.

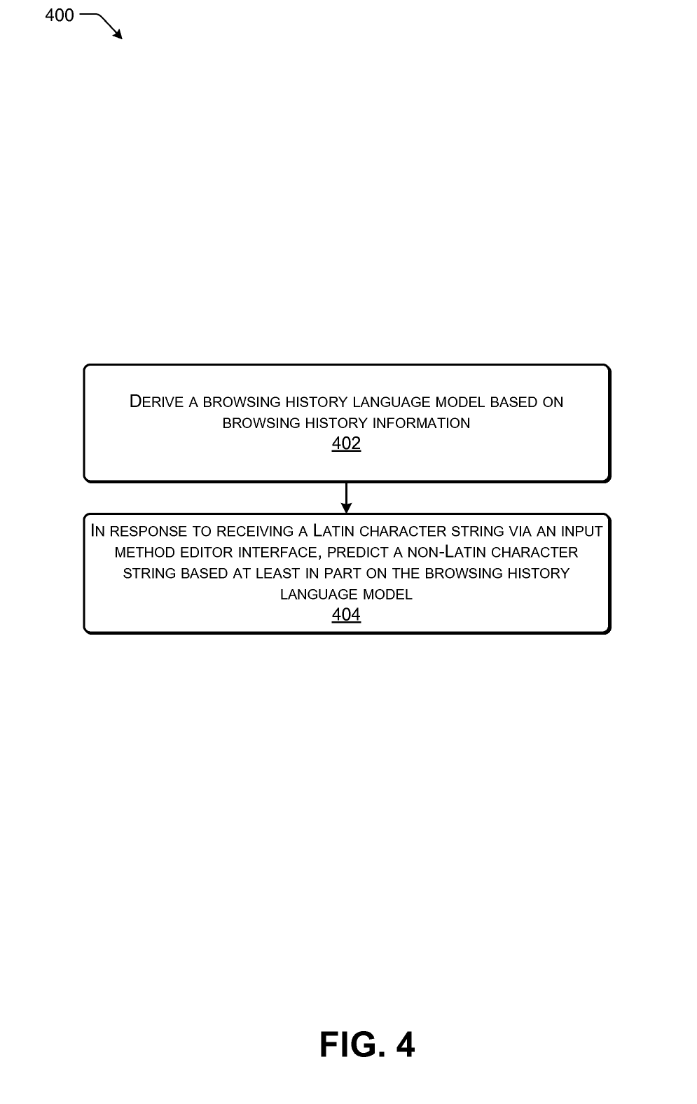

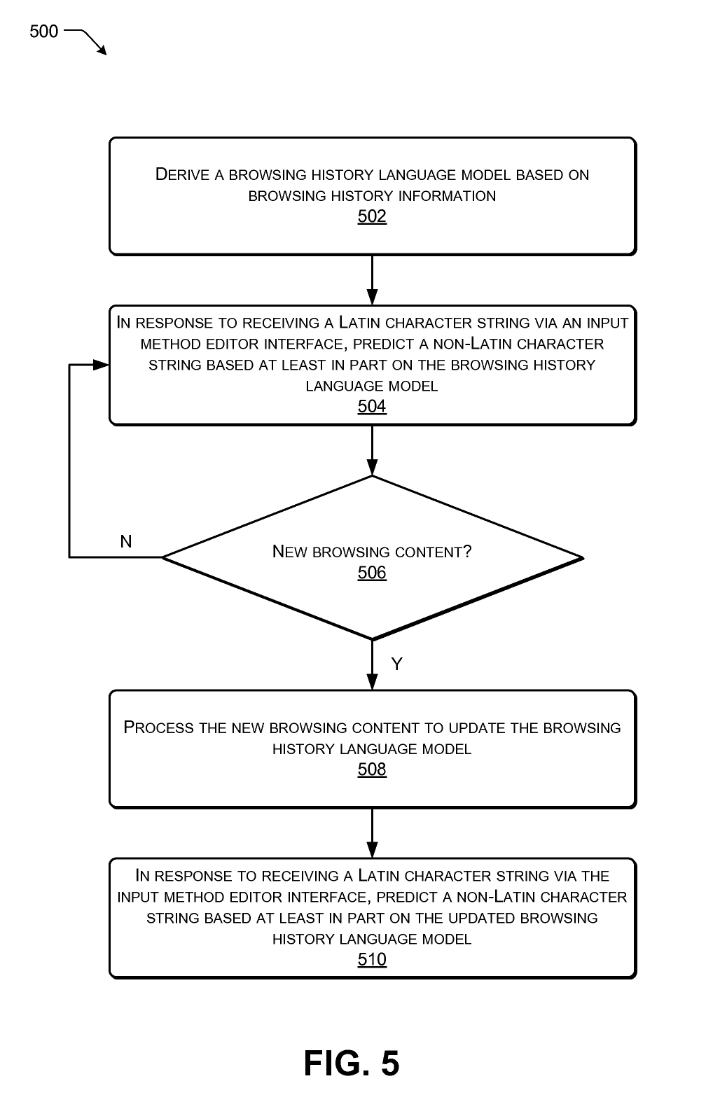

FIGS. 4 and 5 illustrate example process flows according to some implementations. In the flow diagrams of FIGS. 4 and 5, each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. Numerous other variations will be apparent to those of skill in the art in light of the disclosure herein. For discussion purposes, the process flows 400 and 500 are described with reference to the system 100, described above, although other models, frameworks, systems and environments may implement the illustrated process.

Referring to FIG. 4, at block 402, the process flow 400 includes generating a browsing history language model based on browsing history information. For example, the IME application 102 of FIG. 1 may generate the browsing history language model 104 based on the browsing history information 110.

As an illustrative, non-limiting example, an N-gram statistical language model may be employed to analyze the browsing history information 110. Employing such an N-gram SLM, the general language model 106 may identify a first non-Latin character string as the non-Latin character string with the highest conversion probability. Employing the N-gram SLM to analyze the browsing history information 110, the browsing history language model 104 may identify a second non-Latin character string as the non-Latin character string with the highest conversion probability. Depending on the linguistic characteristics of the browsing history information 110, the second non-Latin character string predicted by the browsing history language model 104 may be different from the first non-Latin character string predicted by the general language model 106. Thus, the content of the browsing history information 110 may affect a prediction of a non-Latin character string. Depending on the content of the browsing history information 110, the predicted non-Latin character string may more accurately reflect the interests of the user 118.

In a particular embodiment, a web browser plug-in may filter one or more web pages as the user is browsing in substantially real-time. The plug-in may analyze the data, combine the data with the previous browsing history, and integrate the data into the browsing history language model 104. An advantage of this approach is real-time processing capability, while it may require fast processing to avoid bringing noticeable latency to users. In another embodiment, a system service may periodically check one or more cache folders of one or more browsers and may examine the contents of the cache folders to build the browser history language model 104. This method may be able to examine the browsing history of multiple browsers but may not update the browser history language model 104 in substantially real-time. Alternatively, a web browser plug-in may be responsible for detecting the content update, while a system service may be responsible for building the browser history language model 104.

At block 404, the process flow 400 includes predicting a non-Latin character string based at least in part on the browsing history language model, in response to receiving a Latin character string via an IME interface. For example, the IME application 102 of FIG. 1 may predict the non-Latin character string 124 based at least in part on the browsing history language model 104, in response to receiving the Latin character string 122 via the IME interface 116.

A plurality of non-Latin character strings may be associated with the Latin character string 122 received via the IME interface 116. Multiple non-Latin character strings may be displayed as candidates for user selection. A conversion probability may be associated with each of the non-Latin character string candidates. The conversion probability may be used to determine the order in which the non-Latin character string candidates are displayed.

As an illustrative example, FIG. 2 illustrates an ordered list of non-Latin character strings displayed in response to the user 118 providing the Pinyin text “wan′shang′shi′shi” via the Latin character string input window 202. The non-Latin character string candidates window 204 displays a first Chinese character string candidate [symbol] and a second Chinese character string candidate [symbol] [symbol] . In this case, the conversion probability associated with the first Chinese character string candidate [symbol] was determined to be higher than the conversion probability associated with the second Chinese character string candidate [symbol] .

As another illustrative example, referring to FIG. 3, the non-Latin character string candidates window 204 displays a first Chinese character string candidate [symbol] and a second Chinese character string candidate [symbol] in response to the user 118 providing the Pinyin text “you′xiang′tu” via the Latin character string input window 202. In this case, the conversion probability associated with the first Chinese character string candidate [symbol] was determined to be higher than the conversion probability associated with the second Chinese character string candidate [symbol] .

In a particular embodiment, the predicted non-Latin character string 124 is determined based on the browsing history language model 104 and the general language model 106. In one embodiment, the first Chinese character string candidate (e.g., [symbol] in FIG. 2 or [symbol] in FIG. 3) may represent the non-Latin character string with the highest conversion probability according to the browsing history language model 104. The second Chinese character string candidate (e.g., [symbol] in FIG. 2 or [symbol] in FIG. 3) may represent the non-Latin character string with the highest conversion probability according to the general language model 106.

A contribution of the browsing history language model 104 may be determined based on a weighting factor. For example, the weighting factor may include a default weighting factor or a user-defined weighting factor. In the event that the user 118 determines that the order of the Chinese character string candidates is inappropriate, the user 118 may adjust the weighting factor accordingly.

FIG. 5 illustrates another example process flow according to some implementations. FIG. 5 illustrates that the browsing history language model may be updated based on new browsing content.

At block 502, the process flow 500 includes generating a browsing history language model based on browsing history information. For example, the IME application 102 of FIG. 1 may generate the browsing history language model 104 based on the browsing history information 110.

At block 504, the process flow 500 includes predicting a non-Latin character string based at least in part on the browsing history language model, in response to receiving a Latin character string via an input method editor interface. For example, the IME application 102 of FIG. 1 may predict the non-Latin character string 124 based at least in part on the browsing history language model 104, in response to receiving the Latin character string 122 via the IME interface 116.

At block 506, the process flow 500 includes determining whether the browsing history information includes new browsing content. When it is determined that there is new browsing content, the process flow 500 may proceed to block 508. When new browsing content has not been detected, the process flow 500 returns to block 504. At block 508, the process flow 500 may include processing the new browsing content to update the browsing history language model.

In some implementations, at block 506, a plug-in may detect new browsing content in substantially real-time. For example, referring to FIG. 1, a plug-in associated with the browser application 128 may provide the real-time browsing content 126, and the real-time browsing content 126 may be processed in substantially real-time to update the browsing history language model 104. In an alternative embodiment, at block 506, a system service may periodically monitor one or more browser cache locations to determine whether new browsing content has been saved. The new browsing content may then be processed to update the browsing history language model 104. For example, referring to FIG. 1, a system service may periodically monitor the browser cache 114 for new browsing content and then process the new browsing content to update the browsing history language model 104.

Thereafter, predicting a non-Latin character string may be based at least in part on the updated browsing history language model. For example, at block 510, a Latin character string may be received via the IME interface (e.g., the IME interface 116). In response to receiving this Latin character string, a non-Latin character string is predicted based at least in part on the updated browsing history language model.

In a particular illustrative embodiment, the Latin character string received at block 510 (i.e., after the personal language model has been updated) may be the same as the Latin character string received at block 504. Depending on the update to the browsing history language model resulting from the new browsing content being saved, the predicted non-Latin character string may or may not be the same. That is, the update to the browsing history language model may or may not affect the prediction of the non-Latin character string. To illustrate, the browsing history language model prior to the update (i.e., the browsing history language model generated at 502) may have predicted a particular non-Latin character string. The updated browsing history language model (i.e., after the update at block 508) may predict the same non-Latin character string or may predict a different non-Latin character string.

Thus, updating the browsing history language model may affect a prediction associated with one or more Latin character strings but may not affect a prediction associated with other Latin character strings.

### Example Computing Device and Environment

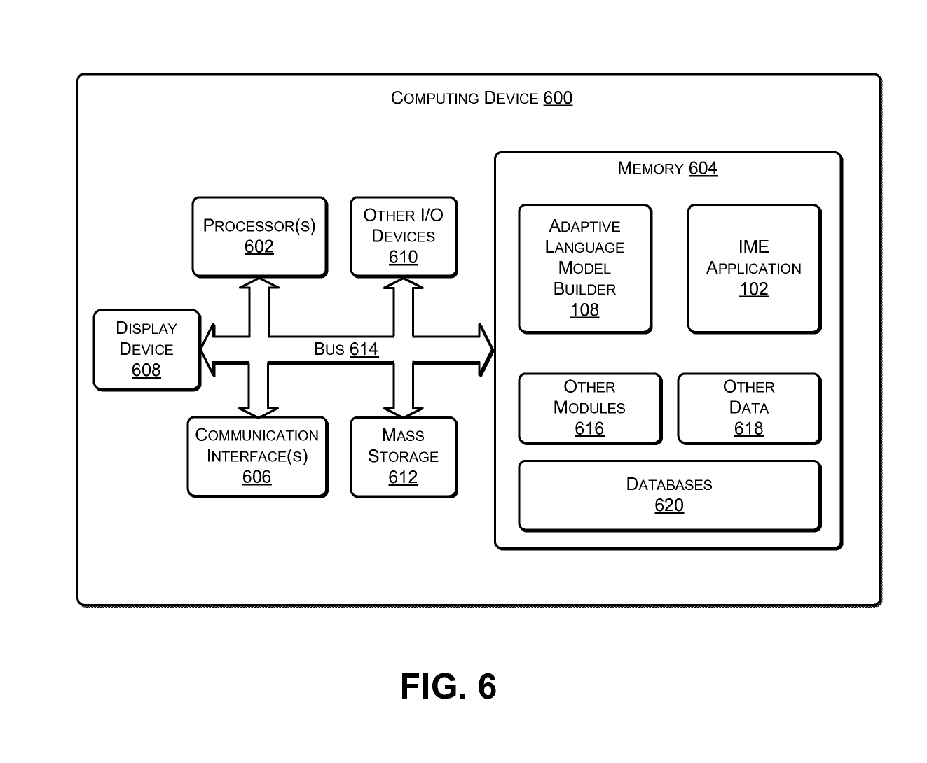

FIG. 6 illustrates an example configuration of a computing device 600 and an environment that can be used to implement the modules and functions described herein. As shown in FIG. 6, the computing device 600 corresponds to the computing device 120 of FIG. 1 but it should be understood that the computing device 120 may be configured in a similar manner to that illustrated.

The computing device 600 may include at least one processor 602, a memory 604, communication interfaces 606, a display device 608 (e.g. a touchscreen display), other input/output (I/O) devices 610 (e.g. a touchscreen display or a mouse and keyboard), and one or more mass storage devices 612, able to communicate with each other, such as via a system bus 614 or other suitable connection.

The processor 602 may be a single processing unit or a number of processing units, all of which may include single or multiple computing units or multiple cores. The processor 602 can be implemented as one or more microprocessors, microcomputers, microcontrollers, digital signal processors, central processing units, state machines, logic circuitries, and/or any devices that manipulate signals based on operational instructions. Among other capabilities, the processor 602 can be configured to fetch and execute computer-readable instructions stored in the memory 604, mass storage devices 612, or other computer-readable media.

Memory 604 and mass storage devices 612 are examples of computer storage media for storing instructions which are executed by the processor 602 to perform the various functions described above. For example, memory 604 may generally include both volatile memory and non-volatile memory (e.g., RAM, ROM, or the like). Further, mass storage devices 612 may generally include hard disk drives, solid-state drives, removable media, including external and removable drives, memory cards, flash memory, floppy disks, optical disks (e.g., CD, DVD), a storage array, a network attached storage, a storage area network, or the like. Both memory 604 and mass storage devices 612 may be collectively referred to as memory or computer storage media herein, and may be computer-readable media capable of storing computer-readable, processor-executable program instructions as computer program code that can be executed by the processor 602 as a particular machine configured for carrying out the operations and functions described in the implementations herein.

The computing device 600 may also include one or more communication interfaces 606 for exchanging data with other devices, such as via a network, direct connection, or the like, as discussed above. The communication interfaces 606 can facilitate communications within a wide variety of networks and protocol types, including wired networks (e.g., LAN, cable, etc.) and wireless networks (e.g., WLAN, cellular, satellite, etc.), the Internet and the like. Communication interfaces 606 can also provide communication with external storage (not shown), such as in a storage array, network attached storage, storage area network, or the like.

The discussion herein refers to data being sent and received by particular components or modules. This should not be taken as a limitation as such communication need not be direct and the particular components or module need not necessarily be a single functional unit. This is not to be taken as limiting implementations to only those in which the components directly send and receive data from one another. The signals could instead be relayed by a separate component upon receipt of the data. Further, the components may be combined or the functionality may be separated amongst components in various manners not limited to those discussed above. Other variations in the logical and practical structure and framework of various implementations would be apparent to one of ordinary skill in the art in view of the disclosure provided herein.

A display device 608, such as touchscreen display or other display device, may be included in some implementations. The display device 608 may be configured to display the IME interface 116 as described above. Other I/O devices 610 may be devices that receive various inputs from a user and provide various outputs to the user, and may include a touchscreen, such as a touchscreen display, a keyboard, a remote controller, a mouse, a printer, audio input/output devices, and so forth.

Memory 604 may include modules and components for execution by the computing device 600 according to the implementations discussed herein. In the illustrated example, memory 604 includes the IME application 102 and the adaptive language model builder 108 as described above with regard to FIG. 1. Memory 604 may further include one or more other modules 616, such as an operating system, drivers, application software, communication software, or the like. Memory 604 may also include other data 618, such as data stored while performing the functions described above and data used by the other modules 616. Memory 604 may also include other data and data structures described or alluded to herein. For example, memory 604 may include information that is used in the course of deriving and generating the browsing history language model 104 as described above.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Although illustrated in FIG. 6 as being stored in memory 604 of computing device 600, the IME application 102 and the adaptive language model builder 108, or portions thereof, may be implemented using any form of computer-readable media that is accessible by computing device 600. As used herein, “computer-readable media” includes, at least, two types of computer-readable media, namely computer storage media and communications media.

Computer storage media includes volatile and non-volatile, removable and non-removable media implemented in any method or technology for storage of information, such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

### CONCLUSION

Although the subject matter has been described in language specific to structural features and/or methodological acts, the subject matter defined in the appended claims is not limited to the specific features or acts described above. Rather, the specific features and acts described above are disclosed as example forms of implementing the claims. This disclosure is intended to cover any and all adaptations or variations of the disclosed implementations, and the following claims should not be construed to be limited to the specific implementations disclosed in the specification. Instead, the scope of this document is to be determined entirely by the following claims, along with the full range of equivalents to which such claims are entitled.

1. A method comprising:
generating a browsing history language model based on browsing history information; and
in response to receiving a Latin character string via an input method editor interface, predicting a non-Latin character string based at least in part on the browsing history language model.

2. The method as recited in claim 1, wherein the browsing history information includes at least cached browsing content.

3. The method as recited in claim 2, wherein the browsing history information further includes real-time browsing content.

4. The method as recited in claim 1, wherein the predicted non-Latin character string is determined based on the browsing history language model and a general language model.

5. The method as recited in claim 4, wherein a contribution of the browsing history language model is determined based on a weighting factor.

6. The method as recited in claim 5, wherein the weighting factor includes a default weighting factor or a user-defined weighting factor.

7. The method as recited in claim 1, further comprising presenting the predicted non-Latin character string via the input method editor interface.

8. The method as recited in claim 1, wherein:
the Latin character string includes a Pinyin character string; and
the predicted non-Latin character string includes a Chinese character string.

9. The method as recited in claim 1, wherein:
a plurality of non-Latin character strings are associated with the Latin character string received via the input method editor interface; and
a conversion probability is associated with each non-Latin character string of the plurality of non-Latin character strings.

10. The method as recited in claim 9, wherein predicting the non-Latin character string includes identifying the non-Latin character string of the plurality of non-Latin character strings with a highest conversion probability.

11. The method as recited in claim 10, wherein a general language model identifies a first non-Latin character string of the plurality of non-Latin character strings as the non-Latin character string with the highest conversion probability.

12. The method as recited in claim 11, wherein the browsing history language model identifies a second non-Latin character string of the plurality of non-Latin character strings as the non-Latin character string with the highest conversion probability.

13. The method as recited in claim 12, wherein the first non-Latin character string identified by the general language model is different than the second non-Latin character string identified by the browsing history language model.

14. The method as recited in claim 1, wherein the browsing history language model includes an N-gram statistical language model.

15. A computing system comprising:
one or more processors;
one or more computer readable media maintaining instructions that, when executed by the one or more processors, cause the one or more processors to perform acts comprising:
generating a browsing history language model based on browsing history information; and
in response to receiving a Latin character string via an input method editor interface, predicting a non-Latin character string based at least in part on the browsing history language model.

16. The computing system as recited in claim 15, the acts further comprising:
detecting new browsing content; and
in response to detecting the new browsing content, processing the new browsing content to update the browsing history language model.

17. The computing system as recited in claim 15, the acts further comprising:
periodically monitoring one or more browser cache locations to determine whether new browsing content has been saved to the one or more browser cache locations; and
processing the new browsing content to update the browsing history language model.

18. One or more computer readable media maintaining instructions that, when executed by one or more processors, cause the one or more processors to perform acts comprising:
generating a browsing history language model based on browsing history information; and
in response to receiving a Latin character string via an input method editor interface:
determining an overall conversion probability of each of a plurality of non-Latin character strings based on a first conversion probability determined based on a general language model and a second conversion probability determined based on the browsing history language model, wherein a contribution of the second conversion probability to the overall conversion probability is weighted based on a weighting factor;
ordering the plurality of non-Latin character strings based on the overall conversion probability; and
displaying an ordered list of non-Latin character strings via the input method editor interface.

19. One or more computer readable media as recited in claim 18, the acts further comprising:
receiving a user-defined weighting factor; and
modifying the weighting factor from a default weighting factor to the user-defined weighting factor.

20. One or more computer readable media as recited in claim 18, wherein the browsing history information includes information stored at a plurality of browser cache locations, each browser cache location associated with a different browser.
